(19) United States
(12) Patent Application Publication
(10) Pub. No.: US 2008/0167374 A1
(43) Pub. Date: Jul. 10, 2008

(54) PESTICIDE COMPOSITION AND METHOD OF USE

(75) Inventors: Chris Stickler, Windsor, CO (US); Randall Worthley, Greeley, CO (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: Loveland Products, Inc., Greeley, CO (US)

(21) Appl. No.: 11/935,115

(22) Filed: Nov. 5, 2007

Related U.S. Application Data
(60) Provisional application No. 60/884,166, filed on Jan. 9, 2007.

(51) Int. Cl. A01N 37/08; A01P 17/00

(52) U.S. Cl. 514/530

(57) ABSTRACT

The invention provides pesticide compositions and methods of use. In particular, pesticide compositions comprises a photolabile pesticide and a UV absorbent.

### CROSS-REFERENCE TO RELATED APPLICATION

This application claims the benefit of Provisional Application No. 60/884,166, filed Jan. 9, 2007, entitled “Pesticide Composition and Method of Use,” which is herein incorporated by reference in its entirety.

### FIELD OF THE INVENTION

The invention relates to pesticide compositions and methods of use. In particular, pesticide compositions comprising a photolabile pesticide and a UV protectant.

### BACKGROUND OF THE INVENTION

When controlling plant pests with the aid of pesticides, the pests to be controlled should be exposed to the pesticide as much as possible so that the pests can take up sufficient amounts of the active compounds. In addition, the pesticide compositions should have a sufficiently long-term action thereby prolonging the pests' exposure to the pesticide. Unfortunately, some pesticides have a relatively short half-life requiring a frequent reapplication in order to control the pest. Some of the factors leading to a relatively short half-life of the pesticide include its instability when exposed to environmental factors such as light, oxygen and the weather.

While there are methods to protect various chemicals from environmental factors, conventional use protecting pesticide compositions from environmental factors are directed to protecting insect attractants from environmental factors. These formulations are designed to protect insect attractants. Some of the methods used to protect insect attractant from environmental factors include microencapsulation, or binding the formulation in water-soluble polymers. In these methods the formulation mixture is dissolved in an oil phase, the resulting mixture is emulsified in water, and the emulsion is subsequently encapsulated. The disadvantage of this process is, however, the complicated microencapsulation process. Moreover, the formulations are not always sufficiently stabilized against environmental factors, despite the encapsulation, because the thin capsule wall does not provide sufficient protection against photochemical degradation.

Other methods involve using one or more permanently liquid UV absorbers. In these methods, the pesticide formulations comprise insecticides and pest attractants. In these methods, the formulation is designed to protect the pest attractant from environmental factors not the pesticide itself. Moreover, many of these methods use a relatively large amount of UV-absorbing substances to protect the attractants against photodegradation over a prolonged period. Furthermore, most of the UV absorbers that are used in these formulations are stable and are not degraded, or are degraded only very slowly. In addition, since these pesticide compositions include a UV absorber that are designed to protect the pest attractant, they necessarily require the presence of a pest attractant.

Accordingly, there is a continuing need for pesticide formulations that are sufficiently stabilized against environmental factors.

### SUMMARY OF THE INVENTION

One embodiment of the present invention provides in part, a pesticide composition comprising a photolabile pesticide and a photoprotectant, e.g., UV protectant.

In some embodiments, the photolabile pesticide is selected from the group consisting of a photolabile insecticide, a photolabile herbicide, a photolabile fungicide, and/or a combination thereof. Within these embodiments, in some instances the photolabile insecticide comprises a photolabile neonicitinoid, a photolabile pyrethroid, a photolabile bio-pesticide, or a combination thereof. Still in other instances the photolabile herbicide comprises a photolabile chloroacetamide, or a combination thereof. Yet in other instances the photolabile fungicide comprises a photolabile biofungicide, or a combination thereof.

In other embodiments, the UV protectant comprises a UV absorbent.

Still in other embodiments, the UV protectant is a mixture of at least two different UV absorbent compounds. Within these embodiments, in some instances at least one of the UV absorbent compound is UV-A absorbent compound and at least one of the other UV absorbent compound is UV-B absorbent compound.

Yet in other embodiments, the UV absorbent absorbs at least 50% of UV light.

Still in other embodiments, the UV protectant comprises an organic compound.

In other embodiments, the pesticide composition further comprises an organic solvent. Within these embodiments, in some instances the pesticide composition further comprises an emulsifier.

Still in other embodiments, the extinction coefficient of UV absorbent is greater than the extinction coefficient of the pesticide within a range of the wavelengths from about 200 nm to about 400 nm, often within a range of wavelength from about 290 nm to about 400 nm.

In one embodiment, invention provides a pesticide composition comprising:
a photolabile pesticide in the amount from about 0.1 to about 60 wt % of the total non-aqueous material;
a UV protectant in the amount from about 1 to about 20 wt % of the total non-aqueous material; and
optionally an additive comprising an emulsifier, an organic solvent, an adjuvant, or a mixture of two or more thereof, wherein the amount of the total amount of additive ranges from about 35 to about 98 wt % of the total non-aqueous material.

In some embodiments, the amount of UV protectant is from about 6 to about 14 wt % of the total non-aqueous material.

In other embodiments, the amount of photolabile pesticide is from about 15 to about 30 wt % of the total non-aqueous material.

In some embodiments, the UV protectant comprises a UV absorbent.

Still in other embodiments, the UV protectant comprises a mixture of a UV A absorbent and a UV B absorbent. Within these embodiments, in some instances the UV absorbent comprises benzophenone-3. Another example of a UV absorbent is Tinuvin 571®.

Yet in other embodiments, the amount of additive is from about 50 to about 70 wt % of the total non-aqueous material.

In some embodiments, the additive comprises an emulsifier and an organic solvent. Within these embodiments, in some instances the amount of emulsifier is from about 3 to about 7 wt % by weight of the total non-aqueous material. In one implementation, the emulsifier can comprise castor oil. Another commercial example of an emulsifier is Sponto AG355N™, available from Witco/Akzo-Nobel. Alternatively, the emulsifier is a mixture of two or more emulsifiers.

Still in other embodiments, the amount of organic solvent is from about 45 to about 65 wt % of the total non-aqueous material.

Another embodiment of the invention provides a method for increasing the half-life of a photolabile pesticide when applied to a plant, said method comprising admixing the photolabile pesticide with a photoprotectant.

In some embodiments, the photoprotectant is a UV protectant.

In some embodiments, the photolabile pesticide and the photoprotectant are mixed prior to applying the photolabile pesticide to a plant.

In other embodiments, the photolabile pesticide and the photoprotectant are applied separately to a plant.

Still in other embodiments, the photolabile pesticide and the photoprotectant are simultaneous applied to a plant from a separate vessel.

Still another aspect of the invention provides a method for increasing the half-life of a photolabile pesticide. The method generally comprises admixing the photolabile pesticide with a photoprotectant that is capable of protecting the photolabile pesticide from the wavelength of light that degrades the photolabile pesticide.

In some embodiments, the amount of photoprotectant present in the admixture is such that the amount of degrading light exposure is reduced by at least about 50%.

Still in other embodiments, the photoprotectant comprises a UV absorbent. Within these embodiments, in some cases the UV absorbent comprises a mixture of compounds comprising a UV-A absorbent compound and a UV-B absorbent compound.

In other embodiments, the light absorbent comprises at least about 10 wt % of the total non-aqueous material, i.e., not including water.

### BRIEF DESCRIPTION OF THE DRAWINGS

FIG. 1A is a line graph depicting the radiation absorption of a commercial insecticide.

FIG. 1B is a line graph depicting the radiation absorption of a test composition.

FIG. 2 is a photograph depicting from containers reflecting the results of a photodegradation test.

FIG. 3A is a photograph depicting the light stalls used in certain experiments described herein.

FIG. 3B is a photograph depicting Petri dishes used in certain experiments described herein.

FIG. 3C is a photograph depicting the results of an experiment relating to the impact of UV exposure on the effectiveness of a composition of pesticide and photoprotectant, according to one embodiment.

FIG. 4A is a graph depicting the time to inactivity of cutworm in one experiment which the compositions were exposed to 236 hours of UV radiation.

FIG. 4B is a graph depicting the time to inactivity of cutworm in one experiment which the compositions were exposed to 260 hours of UV radiation.

FIG. 4C is a graph depicting the time to inactivity of cutworm in one experiment which the compositions were exposed to 306.5 hours of UV radiation.

FIG. 4D is a graph depicting the average time to inactivity of cutworms in one experiment in which the compositions were exposed to 236, 260, and 306.5 hours of UV radiation.

FIG. 5 is a graph depicting the average time to cutworm death in another experiment in which the compositions were exposed to various time periods of UV radiation.

### DETAILED DESCRIPTION OF THE INVENTION

Some pesticides are light, in particular ultraviolet (UV) light, sensitive. These pesticides are often inactivated and/or are degraded by UV light. Accordingly sunlight lessens the effectiveness of these pesticides and often results in repeated application, thereby increasing the labor time and cost. Exemplary pesticides that are UV light sensitive include insecticides (e.g., neonicitinoids, pyrethroids, and some bio-insecticides), herbicides (e.g., dinitroanalines), and fungicides (e.g., some biological fungicides). Other representative UV light sensitive pesticides and further pesticide active ingredients that may be incorporated into compositions discussed herein are listed in Table 1.

TABLE 1
Active Ingredient

(+)-(R)-2-(4-Chloro-2-methylphenoxy)propanoic acid
(+−)-2-(4,5-Dihydro-4-methyl-4-(1-methylethyl)-5-oxo-1H-imidazol-2-yl)-5-metho**
(4,5-dihydro-3-methoxy-4-methyl-5-oxo-N-{{2-(trifluoromethoxy}-phenyl}sulfonyl**
(7S)-Hydroprene
(E)-5-Decen-1-ol
(E,E)-8,10-Dodecadien-1-ol
(R)-2-(2,4-Dichlorophenoxy)propanoic acid, dimethylamine salt
(R,Z)-5-(1-Decenyl)dihydro-2(3H)-furanone
(R + S)-alpha-Cyano-3-phenoxybenzyl (1S + 1R)-cis-3-(Z-2-chloro-3,3,3-trifluoropro**
(S)-2-Chloro-N-(2-ethyl-6-methylphenyl)-N-(2-methoxy-1-methylethyl) acetamide
(S)-2-Chloro-N-{(1-methyl-2-methoxy)ethyl}-N-(2,4-dimethyl-thien-3-yl) acetam**
(Z)-11-Hexadecenal
(Z)-11-Hexadecenyl acetate
(Z)-11-Tetradecenyl acetate
(Z)-4-Tridecen-1-yl acetate
(Z)-8-Dodecen-1-yl acetate
(Z)-9-Tricosene
(Z,E)-7,11-Hexadecadien-1-yl acetate
(Z,E)-9,12-Tetradecadienyl acetate
.beta.-Alanine, N-acetyl-N-butyl-, ethyl ester
?3-?(6-Chloro-3-pyridinyl)methylU-2-thiazolidinylideneUcyanamide
1-(2,4-Dichlorophenylaminocarbonyl)cyclopropanecarboxylic acid
1-(3-Chloroallyl)-3,5,7-triaza-1-azoniaadamantane chloride
1-(4,6-dimethoxypyrimidin-2-yl)-3-(2-ethylsulfonylimidazo{1,2-a}pyridin-3-ylsu**
1,2,3-Benzothiadiazole-7-carbothioic acid, S-methyl ester
1,2,4-Triazin-3(2H)-one, 4,5-dihydro-6-methyl-4-{(3-pyridinylmethylene)amino}-**
1,2,4-Triazin-5(4H)-one, 4-amino-6-(1,1-dimethylethyl)-3-(methylthio)-
1,2-Benzisothiazolin-3-one
1,2-Benzisothiazolin-3-one, 2-butyl-
1,3-Dibromo-5,5-dimethylhydantoin
1,3-Dichloropropene
1,3-Propanediamine, N-(3-aminopropyl)-N-dodecyl-
1,4-Bis(bromoacetoxy)-2-butene
1,4-Dioxaspiro?4,5Udecane-2-methanamine, 8-(1,1-dimethylethyl)-N-ethyl-N-propy**
1,4-Naphthalenedione, 2-(acetyloxy)-3-dodecyl-
1,7-Dioxaspiro[5.5] undecane
10,10′-Oxybisphenoxarsine
11-Tetradecen-1-ol, acetate, (E)-
1-Bromo-1-(bromomethyl)-1,3-propanedicarbonitrile
1-Bromo-3-chloro-5,5-dimethylhydantoin
1-Decanol
1H-1,2,4-Triazole-1-ethanol, .alpha.-(2-(4-chlorophenyl)ethyl)-.alpha.-(1,1-di**
1H-Imidazole-1-sulfonamide, 4-chloro-2-cyano-N,N-dimethyl-5-(4-methylphenyl)-
1H-Purine-2,6-dione, 3,7-dihydro-
1H-Pyrrole-3-carbonitrile, 4-bromo-2-(4-chlorophenyl)-1-(ethoxymethyl)-5-(trif**
1H-Pyrrole-3-carbonitrile,4-bromo-2-(4-chlorophenyl)-5-(trifluoromethyl)-
1-Octen-3-ol (mixed isomers-recemic mixture)(For R-isomer see PC Code 069038)
1-Octen-3-ol, (3R)
2-(octylthio)ethanol
2-((Hydroxymethyl)amino)ethanol
2-(1-Methyl-2-(4-phenoxyphenoxy)ethoxy)pyridine
2-(Decylthio)ethanamine hydrochloride
2-(Ethylamino)-4-(isopropylamino)-6-(methylthio)-s-triazine
2-(Hydroxymethyl)-2-nitro-1,3-propanediol
2-(tert-Butyl)-5-(4-tert-butyl-benzylthio)-4-chloropyridazin-3-(2H)one
2-(Thiocyanomethylthio)benzothiazole
2,2-Dibromo-3-nitrilopropionamide
2,4-D
2,4-DB
2,4-Dinitro-N3,N3-dipropyl-6-(trifluoromethyl)-1,3-benzenediamine (Note: N3 = **
2,4-Dodecadienoic acid, 11-methoxy-3,7,11-trimethyl-, 1-methylethyl ester, **
2-{1-{{{(3,5-difluorophenyl)amino}carbonyl}hydrazono}ethyl}-3-pyridinecarboxyl**
2-{4-(methylsulfonyl)-2-nitrobenzoyl}-1,3-cyclohexanedione
2-Benzyl-4-chlorophenol
2-Bromo-4′-hydroxyacetophenone
2-Cyclohexen-1-one, 2-{1-{{(3-chloro-2-propenyl)oxy}imino}propyl}-3-hydroxy-5-**
2-Ethylhexyl (R)-2-(2,4-dichlorophenoxy)propionate
2-Hydroxyethyl octyl sulfide
2-Methyl-3(2H)-isothiazolone
3-(Trimethoxysilyl)propyl dimethyl octadecyl ammonium chloride
3-Chloro-5-(((((4,6-dimethoxy-2-pyrimidinyl)amino)carbonyl)amino)sulfonyl)-1-m**
3-Chloro-N-(3-chloro-2,6-dinitro-4-(trifluoromethyl)phenyl)-5-(trifluoromethyl**
3H-1,2-Dithiol-3-one, 4,5-dichloro-
3-Iodo-2-propynyl butylcarbamate
3-Methyl-2-cyclohexen-1-one
3-Pyridinecarboxamide, 2-chloro-N-(4′-chloro?1,1′-biphenylU-2-yl)-
3-Pyridinecarboxamide, N-(cyanomethyl)-4-(trifluoromethyl)-
3-Pyridinecarboxylic acid, 2-{1-{{{(3,5-difluorophenyl)amino}carbonyl}hydrozon**
4-(p-Acetoxyphenyl)-2-butanone
4,5-Dichloro-2-n-octyl-3(2H)-isothiazolone
4,6-Dimethyl-N-phenyl-2-pyrimidinamine
4-Chloro-3-cresol
4″-Epimethylamino-4″-deoxyavermectin B1a and B1b benzoates
4H-Imidazol-4-one, 3,5-dihydro-5-methyl-2-(methylthio)-5-phenyl-3-(phenylamino**
4-Iodo-2-????(4-methoxy-6-methyl-1,3,5-triazin-2-yl-)aminoUcarbonylUaminoUsulf**
4-tert-Amylphenol
5-[(4-Chlorophenyl)methylene]-2,2-dimethyl-1-(1H-1,2,4-triazol-1-ylmethyl)cycl**
5-Chloro-2-methyl-3(2H)-isothiazolone
5-Hydroxymethoxymethyl-1-aza-3,7-dioxabicyclo(3.3.0)octane
6-Heneicosen-11-one, (6Z)-
9-(4-Chloro-2-fluoro-5-methoxycarbonylmethylthiophenylimino)-8-thia-1,6-diazab**
9-Dodecenyl acetate, (Z)-
Abamectin
Acephate
Acequinocyl
Acetamide, 2-chloro-N-(2,4-dimethyl-3-thienyl)-N-(2-methoxy-1-methylethyl)-
Acetamiprid
Acetic acid, (2,4-dichlorophenoxy)-, 2-ethylhexyl ester
Acetochlor
Acifluorfen
Aclonifen
Acrolein
Alachlor
Alanycarb
Alkyl* dimethyl benzyl ammonium chloride *(50% C14, 40% C12, 10% C16)
Allethrin
Ametryn
Amicarbazone
Amines, N-coco alkyltrimethylenedi-
Amino-4,5-dihydro-N-(1,1-dimethylethyl)-3-(1-methylethyl)-5-oxo-1H-1,2,4**
Aminoethoxyvinylglycine hydrochloride
Aminopyralid
Amitraz
Amitrole
Ammonia
Ammonium bromide
Ancymidol
Anthraquinone
Arsenic acid
Arsenous acid anhydride
Aspergillus flavus NRRL 21882
Asulam, sodium salt
Atrazine
Azadirachtin
Azafenidin
Azimsulfuron
Azinphos-methyl
Azoxystrobin
Bacillus thuringiensis subspecies israelensis Strain BMP 144 solids, s**
Bacillus thuringiensis subspecies kurstaki strain SA-12 solides, spores,
Bacillus thuringiensis, subspecies kurstaki strain SA-11 solids, spor**
Bacillus cereus strain UW85
Bacillus pumilus GB34
Bacillus pumilus strain QST 2808
Bacillus sphaericus
Bacillus subtilis GB03
Bacillus subtilis var. amyloliquefaciens Strain FZB24
Bacillus thuringiensis Cry2Ab protein and the genetic material necessary for i**
Bacillus thuringiensis subsp. aizawai strain GC-91
Bacillus thuringiensis subsp. aizawai, strain NB200
Bacillus thuringiensis subsp. israelensis
Bacillus thuringiensis subsp. kurstaki strain BMP123
Bacillus thuringiensis subsp. kurstaki strain EG2348
Bacillus thuringiensis subsp. kurstaki strain EG2371
Bacillus thuringiensis Subsp. Kurstaki, Strain ABTS-351
Bacillus thuringiensis subspecies israelensis strain EG2215
Bacillus thuringiensis subspecies kurstaki, strain EG7826 Lepidopteran active **
Bacillus thuringiensis subspecies tenebrionis, strain NB-176
Bacillus thuringiensis var. kurstaki delta endotoxin protein as produced by th**
Bacillus thuringiensis, subsp. strain ABTS 1857
BAS 625 H
Basic cupric sulfate
Beauveria bassiana ATCC 74040
Benefin
Benfluralin
Benoxacor
Bensulfuron-methyl
Bensulide
Bentazone
Benzamide, N-[[[2,5-dichloro-4-(1,1,2,3,3,3-hexafluoropropoxy)phenyl] amino]**
Benzene, pentachloronitro-
Benzene, 1-methoxy-4-(2-propenyl)-
Benzenesulfonamide, 2-(2,2-difluoroethoxy)-N-(5,8-dimethoxy[1,2,4]triazolo[1,5**
Benzyl benzoate
Benzyl dimethyl tetradecyl ammonium chloride
beta-Bromo-beta-nitrostyrene
beta-cyfluthrin
Bethoxazin
Bifenezate
Bifenthrin
Bioallethrin
Bioallethrin S-cyclopentenyl Isomer
Bioresmethrin
Bis(tributyltin) oxide
Bitertanol
Bomoxynil octaniate
Borax (B4Na2O7•10H2O) (1303-96-4)
Boric acid
Boric acid (H3BO3), polymer with N-decyl-1-decanamine, oxirane and 1,2-propan**
Boric oxide
Boron sodium oxide (B4Na2O7), pentahydrate
Boron sodium oxide (B8Na2O13), tetrahydrate (12280-03-4)
Brewer's yeast extract hydrolysate from Saccharomyces cerevisiae
Brodifacoum
Bromacil
Bromadiolone
Bromethalin
Bromine chloride
Bromoxynil
Bromoxynil butyrate
Bromoxynil heptanoate
Bromuconazole
Bronopol
Bupirimate
Buprofezin
Butafenacil
Butanoic acid, 2,2-dimethyl-, 3-(2,4-dichlorophenyl)-2-oxo-1-oxaspiro[4,5]dec-**
Butanoic acid, 3,3-dimethyl-, 2-oxo-3-(2,4,6-trimethylphenyl)-1-oxaspiro[4.4]n**
Butoxyethyl 2,4-dichlorophenoxyacetate
Butoxyethyl triclopyr
Butoxypolypropoxypolyethoxyethanol-iodine complex
Butoxypolypropylene glycol
Butralin
Butylate
Cacodylic acid
Cadusafos
Calcium hydroxide (Ca(OH)2)
Calcium hypochlorite
Calcium oxytetracycline
Captan
Carbaryl
Carbendazim
Carbofuran
Carbonic acid, monoammonium salt
Carboxin
Carfentrazone-ethyl
Carpropamide
Chloramben
Chlordane
Chlorethoxyfos
Chlorfluazuron
Chlorflurenol-methyl
Chlorflurenol, methyl ester
Chlorhexidine diacetate
Chlorimuron-ethyl
Chlorine
Chlormequat chloride
Chloroneb
Chlorophacinone
Chloropicrin
Chlorothalonil
Chloroxylenol
Chlorpropham
Chlorpyrifos
Chlorpyrifos-methyl
Chlorsulfuron
Chondrostereum purpureum isolate PFC 2139, ATCC 60854
Chromafenozide
Chromic acid
Cinidon-ethyl
Cinmethylin
Cinosulfuron
cis-7,8-Epoxy-2-methyloctadecane
cis-7,8-Epoxy-2-methyloctadecane
Citric acid
Clethodim
Clodinafop-propargyl (CAS Reg. No. 105512-06-9)
Clofencet
Clofentezine
Clomazone
Clopyralid
Clopyralid, monoethanolamine salt
Cloransulam-methyl
Clothianidin
Coal tar creosote
Codlemone
Cooper carbonate
Copper (metallic)
Copper ethanolamine complex
Copper hydroxide
Copper naphthenate
Copper oxychloride
Copper oxychloride sulfate
Copper sulfate pentahydrate
Copper triethanolamine complex
Copper(I) oxide
Copper(II) oxide
Copper, bis[1-cyclohexyl-1,2-di(hydroxy-.kappa.O)diazeniumato(2-)]-
Coumaphos
Coumatetralyl
Creosote oil (Note: Derived from any source)
Cryolite
Cuprous thiocyanate
Cyclanilide
Cyclohexanecarboxylic acid, 4(or 5)-chloro-2-methyl-,1,1-dimethylethyl ester
Cyclohexene, 1-methyl-4-(1-methylethenyl)-
Cyclopentanol, 2-[(4-chlorophenyl)methyl]-5-(1-methylethyl)-1-(1H-1,2,4-triazo**
Cyclopropanecarboxylic acid, 2,2-dimethyl-3-(1-propenyl)-, [2,3,5,6-tetraf**
Cyclopropene,1-methyl-
Cyfluthrin
Cyhalothrin
Cyhexatin
Cymoxanil
Cypermethrin
Cyphenothrin
Cyproconazole
Cyprodinil
Cyromazine
Cytokinin (as kinetin)
d-Allethrin
Daminozide
Dazomet
DCPA (or chlorthal-dimethyl?)
DDT
Decanoic acid, monoester with 1,2,3-propanetriol
Decyl isononyl dimethyl ammonium chloride
Deltamethrin
Desmedipham
Diazinon
Dicamba
Dicamba, dimethylamine salt
Dicamba, potassium salt
Dicamba, sodium salt
Dichlobenil
Dichlofluanide
Dichlorophen
Dichlorprop-P
Dichlorvos
Dichromic acid, (H2Cr2O7), disodium salt, dehydrate
Diclofop-methyl
Diclomezin
Dicloran
Dicofol
Dicrotophos
Didecyl dimethyl ammonium carbonate and didecyl dimethyl ammonium bicarbonate
Didecyl dimethyl ammonium chloride
Difenoconazole
Difenzoquat methyl sulfate
Difethialone
Diflubenzuron
Diflufenzopyr
Diisobutylcresoxyethoxyethyl dimethyl benzyl ammonium chloride
Diisobutylphenoxyethoxyethyl dimethyl benzyl ammonium chloride
Dimethenamid
Dimethipin
Dimethirimol
Dimethoate
Dimethomorph
Dimethylamine (R)-2-(2-methyl-4-chlorophenoxy)propionate
Dimethylamine 2,4-dichlorophenoxyacetate
Dimethylamine 4-(2,4-dichlorophenoxy)butyrate
Dimethylvinphos
Dinitramine
Dinocap
Dioctyl dimethyl ammonium chloride
Diphacinone
Diphenylamine
Dipropyl isocinchomeronate
Diquat dibromide
Disodium cyanodithioimidocarbonate
Disulfoton
Dithiopyr
Diuron
DMDM Hydantoin
DNOC
Dodecanoic acid, monoester with 1,2,3-propanetriol
Dodecanoic acid, monoester with 1,2-propanediol
Dodecylguanidine hydrochloride
Dodine
D-Phenothrin
Dried fermentation solids & solubles of myrothecium verrucaria
d-trans-Allethrin
d-trans-Chrysanthemum monocarboxylic acid ester of d-2-allyl-4-hydroxy-3-methy**
E,Z-3,13-Octadecadien-1-ol
Edifenphos
Emamectin Benzoate
Endosulfan
Endothall
EPTC
Ergocalciferol
Esbiothrin
Esfenvalerate
Espesol 3A
Esprocarb
Ethalfluralin
Ethametsulfuron
Ethametsulfuron-methyl
Ethephon
Ethiofencarb
Ethirimol
Ethofenprox
Ethofumesate
Ethoprop
Ethyl 1-naphthaleneacetate
Ethyl 2-chloro-5-[4-chloro-(5-difluoromethoxy)-1-methyl-1H-pyrazol-3-yl]-4-flu**
Ethyl alcohol
Ethylene
Ethylene dibromide
Ethylene oxide
Etoxazole
Etridiazole
Etridiazole
Fats and glyceridic oils, margosa
Femoxadone
Fenamiphos
Fenarimol
Fenazaquin
Fenbuconazole
Fenbutatin-oxide
Fenhexamid
Fenothiocarb
Fenoxycarb
Fenpropathrin
Fentin hydroxide
Fentrazamide
Fenvalerate
Fipronil
Fir Needle Oil
Flazasulfuron
Fluazifop-P-butyl
Fluchloralin
Flucycloxuron
Flucythrinate
Fludioxonil
Flumetralin
Flumetsulam
Flumiclorac-pentyl
Flumioxazin
Fluometuron
Fluoroglycofen-ethyl
Fluridone
Flurochloridone
Fluroxypyr 1-methylheptyl ester
Flurprimidol
Fluthiacet-methyl
Flutolanil
Fluvalinate
Folpet
Fomesafen
Fomesafen Sodium
Formaldehyde
Formetanate hydrochloride
Fosetyl-Al
Fosthiazate
Fuberidazole
gamma-cyhalothrin
Gibberellic acid
Gibberellin A4 mixt. with Gibberellin A7
Glufosinate-ammonium
Glutaral
Glycine, N-(phosphonomethyl)-potassium salt
Glycolic acid
Glyphosate
Glyphosate, ammonium salt
Glyphosate, dimethylammonium salt
Glyphosate, isopropylamine salt
Guanidine, N-methyl-N′-nitro-N″-[(tetrahydro-3-furanyl)methyl]-
Halofenozide
Hexaflumuron
Hexahydro-1,3,5-tris(2-hydroxyethyl)-s-triazine
Hexazinone
Hexythiazox
Hydramethylno
Hydramethylnon
Hydrogen peroxide
Hydroprene
Hymexazol
IBA
Imazalil
Imazamethabenz-methyl
Imazamox
Imazapic
Imazapyr
Imazapyr, isopropylamine salt
Imazaquin
Imazethapyr
Imidacloprid
Imiprothrin
Indoxacarb
Iodine
Iodosulfuron-methyl-sodium
Ioxynil
Iprodione
Isofenphos
Isopropyl 2,4-dichlorophenoxyacetate
Isopropylamine 2,4-dichlorophenoxyacetate
Isoxaben
Isoxaben
Isoxaflutole
Kaolin
Kinoprene
Kresoxim-methyl
Lactofen
Lagenidium giganteum, mycelium or oospores
Linalool
Linuron
Lithium hypochlorite
L-Lactic acid
Lysophosphatidylethanolamines, egg yolk
Malathion
Maleic hydrazide
Mancozeb
Maneb
MCPA
MCPA (and salts and esters)
MCPA, 2-ethylhexyl ester
MCPA, dimethylamine salt
MCPB (and salts)
MCPB, sodium salt
Mefenpyr-diethyl
Mefluidide
Mefluidide, diethanolamine salt
Mercuric Chloride
Mercuric Oxide
Mercurous Chloride
Mesotrione
Metalaxyl
Metalaxyl-M
Metaldehyde
Metamitron
Metam-sodium
Metarhizium anisopliae strain F52 spores
Methabenzthiazuron
Methamidophos
Methanone, [2-[[6-(2-chlorophenoxy)-5-fluoro-4-pyrimidinyl]oxy]phenyl] (5,6-d**
Methidathion
Methiocarb
Methomyl
Methoprene
Methoxyfenozide
Methyl 2-[3-(4,6-dimethoxypyrimidin-2-yl)ureidosulfonyl]-4-methanesulfonamidom**
Methyl anthranilate
Methyl bromide
Methyl eugenol
Methyl isothiocyanate
Methyl nonyl ketone
Methyl parathion
Methylene bis(thiocyanate)
Metiram
Metolachlor
Metominostrobin
Metoxuron
Metribuzin
Metsulfuron-methyl
Milbemectin (A mixture of >=70% Milbemcin A4, & <=30% Milbemycin A3)
Mineral oil-includes paraffin oil from 063503
MKH 6561
Molinate
Monolinuron
Morpholine, 3-(3-(4-chlorophenyl)-3-(3,4-dimethoxyphenyl)-1-oxo-2-propenyl)
Muscodor albus strain QST 20799
Myclobutanil
N-phenylphthalamic acid
N-(2,6-dichlorophenyl)-5-ethoxy-7-fluoro-(1,2,4)triazolo(1,5-c)pyrimidine-2-su**
N-(4-Fluorophenyl)-N-(1-methylethyl)-2((5-(trifluoromethyl)-1,3,4-thiadiazol-2**
N-(Mercaptomethyl)phthalimide S-(O,O-dimethyl phosphorodithioate)
N-(Phenylmethyl)-1H-purin-6-amine
N,N-Diethyl-meta-toluamide and other isomers
N,N-Dimethyl-2-?3-(4,6-dimethoxypyrimidin-2-yl)ureidosulfonylU-4-formylaminobe**
NAA
Nabam
NAD
Nalad
Naphthalene
Naphthalene, 1,4-dimethyl-
Naproanilide
Napropamide
Navel orangeworm pheromone
N-Cyclopropyl-N′-(1,1-dimethylethyl)-6-(methylthio)-1,3,5-triazine-2,4-diamine
Nicarbazin
Niclosamide
Nicosulfuron
Nicotine
Nitrapyrin
N-Methylneodecanamide
N-Octyl bicycloheptene dicarboximide
Nonylphenoxypolyethoxyethanol-iodine complex
Norflurazon
Nosema locustae
Novaluron
Noviflumuron
Nuarimol
O,O-Dimethyl O-(4-nitro-m-tolyl) phosphorothioate
Octanoic acid, ester with 1,2-propanediol
Octhilinone
Ofurace
Oil of eucalyptus
o-Phenylphenol
Orbencarb
Orthosulfamuron
Oryzalin
Oxadiazon
Oxamyl
Oxine-copper
Oxycarboxin
Oxydemeton-methyl
Oxyfluorfen
Oxytetracycline hydrochloride
Paclobutrazol
Paecilomyces fumosoroseus Apopka Strain 97
Paradichlorobenzene
Paraquat dichloride
Parathion-methyl
Pefurazoat
Penconazole
Pencycuron
Pendimethalin
Pentachlorophenol
Permethrin
Petroleum distillate, oils, solvent, or hydrocarbons; also paraffinic hydrocar**
Phenmedipham
Phenol, 5-chloro-2-(2,4-dichlorophenoxy)-
Phorate
Phosmet
Phosphorous acid
Phostebupirim
Phoxim
Picaridin
Picloram
Picloram, potassium salt
Picolinafen
Pine oil
Pinoxaden
Piperalin
Piperidinium, 1,1-dimethyl-, chloride
Piperonyl butoxide
Pirimicarb
Pirimiphos-methyl
Plant extract* (*Derived from quercus falcata, opuntia lindheimer, rhus aromat**
p-Menthane-3,8-diol
Poly(iminoimidocarbonyliminoimidocarbonyliminohexamethylene) hydrochloride
Poly(oxyethylene(dimethyliminio)ethylene(dimethyliminio)ethylene dichloride)
Polyoxin D zinc salt
Polyxylenol tetrasulfide
Potassium dimethyldithiocarbamate
Potassium silicate
Prallethrin
Primisulfuron-methyl
Prochloraz
Prodiamine
Profenofos
Prohexadione calcium
Prometon
Prometryn
Propachlor
Propanil
Propanoic acid, 2-?4-(4-cyano-2-fluorophenoxy)phenoxyU-, butyl ester, (R)—
Propanoic acid, 2-?4-?(6-chloro-2-quinoxalinyl)oxyphenoxyU-, ethylester, (R)—
Propanoic acid, 2-{4-{(6-chloro-2-benzoxazolyl)oxy}phenoxy}-, ethyl ester, (R)**
Propargite
Propazine
Propetamphos
Propiconazole
Propionic acid
Propoxur
Propoxycarbazone-sodium
Propylene oxide
Propyzamide
Prosulfuron
Prothioconazole
Prothiofos
Pseudomonas syringae
Pseudomonas syringae, strain ESC-11
Pseudozyma flocculosa
Pymetrozine
Pyraclostrobin
Pyrethrins
Pyrethrins (Pyrethrum)
Pyridaben
Pyrithiobac-sodium
Pyroquilon
Pythium oligandrum DV 74 (ATCC 38472) (A Filamentous Fungus)
QST 713 strain of bacillus subtilis
Quinclorac
Quinoxyfen
Quizalofop-ethyl
Resmethrin
Reynoutria sachalinensis
Rimsulfuron
Rotenone
RU 15525
S-(2-Hydroxypropyl) thiomethanesulfonate
S-(O,O-Diisopropyl phosphorodithioate) ester of N-(2-mercaptoethyl)benzenesulf**
Sabadilla
Saccharopolyspora spinosa fermentation product containing Spinosad
Sethoxydim
Siduron
Silicon dioxide
Silver
Silver chloride
Silver sodium hydrogen zirconium phosphate (Ag0.18Na0.57H0.25Zr2(PO4)3)
Simazine
Sodium 1-naphthaleneacetate
Sodium 2,4-dichlorophenoxyacetate
Sodium 2,6-bis[(4,6-dimethoxypyrimidin-2-yl)oxy] benzoate
Sodium 5-nitroguaiacolate
Sodium acifluorfen
Sodium bentazon
Sodium bicarbonate
Sodium bromide
Sodium chlorate
Sodium chlorite
Sodium dichloroisocyanurate dihydrate
Sodium dichloro-s-triazinetrione
Sodium dimethyldithiocarbamate
Sodium fluoride
Sodium fluoroacetate
Sodium hypochlorite
Sodium o-nitrophenolate
Sodium o-phenylphenate
Sodium p-chloro-m-cresolate
Sodium percarbonate
Sodium p-nitrophenolate
Sodium silver thiosulfate
Spinosad
Starlicide
Streptomycin sesquisulfate
Strychnine
Sulfentrazone
Sulfluramid
Sulfometuron methyl
Sulfosulfuron
Sulfur
Sulfuric acid, monourea adduct
Sulprofos
Tebufenozide
Tebufenpyrad
Tebuthiuron
Tebuthiuron
Tecloftalam
Tecnazene
Tefluthrin
Temephos
Tepraloxydim
Terbacil
Terbufos
Terbuthylazine
Terbutryn
tert-Butyl (E)-4-(((((1,3-dimethyl-5-phenoxy-1H-pyrazol-4-yl)methylene)amino)o**
Tetraacetylethylenediamine
Tetrachlorvinphos ((Z)-isomer)
Tetraconazole
Tetrahydro-2-(nitromethylene)-2H-1,3-thiazine
Tetrakis(hydroxymethyl)phosphonium sulphate (THPS)
Tetramethrin
Thenylchlor
Thiabendazole
Thiamethoxam
Thiazopyr
Thidiazuron
Thifensulfuron-methyl
Thiobencarb
Thiodicarb
Thiophanate-methyl
Thiram
Tolclofos-methyl
Tolylfluanid
Tralkoxydim
Tralomethrin
Triadimefon
Triadimenol
Triallate
Triasulfuron
Triazoxide
Tribenuron-methyl
Tribufos
Trichlorfon
Trichlorfon
Trichloromelamine
Trichloro-s-triazinetrione
Triclopyr
Triclopyr
Triethylamine triclopyr
Trifloxystrobin
Trifloxysulfuron-sodium
Triflumizole
Trifluralin
Triflusulfuron-methyl
Triforine
Triforine
Triisopropanolamine 2,4-dichlorophenoxyacetate
Trinexapac-ethyl
Uniconazole
Vernolate
Vinclozolin
Warfarin
Zeta-Cypermethrin
Zinc
Zinc 2-pyridinethiol-1-oxide
Zinc borate (3ZnO, 2B03, 3.5H2O; mw 434.66)
Zinc naphthenate
Zinc oxide
Zinc phosphide (Zn3P2)
Zineb
Ziram
Zoxamide
ZXI 8901

Pesticide compositions of the invention include a photoprotectant, typically a UV protectant, thereby increasing the half-life of the photolabile pesticide. As used herein, the term “photolabile pesticide” refers to a pesticide that is sensitive, i.e., degraded and/or inactivated, by light, typically UV light. UV light is defined as electromagnetic radiation having wavelengths from about 200 nm 400 nm, typically from 290 nm to 400 nm. Within this range of wavelengths, UV light can be subdivided into UV-A (wavelength from about 320 to about 400 nm) and UV-B (wavelength from about 290 to about 320 nm).

A photoprotectant refers to any compound that can prolong the half-life of photolabile pesticide or increase the stability of photolabile pesticide when exposed to light. A photoprotectant typically absorbs, blocks, and/or reflects at least a portion of the harmful light to reduce the amount of exposure to the photolabile pesticide. In some embodiments, the photoprotectant is a UV protectant. Within these embodiments, in certain cases the photoprotectant is a UV absorbent. The term “UV absorbent” refers to any compound or substance that absorbs UV radiation. A UV absorbent can either scatter or absorb UV radiation. Zinc oxide and titanium dioxide are two examples that scatter UV radiation. UV absorbents used in the invention are often organic compounds that absorb UV radiation. Organic compounds that absorb UV radiation are well known to one skilled in the art. For example, a number of these compounds are often used in “sun screen” preparation. Exemplary UV absorbents that are useful in the invention include, but are not limited to, para-aminobenzoic acid (PABA), octyl methoxycinnamate (OMC), 4-methylbenzylidene camphor (4-MBC), avobenzone, oxybenzone, benzotriazole and derivatives (such as commercially available absorbent Tinuvin 571®), homosalate, polyflavinoids such as Shade®, and Benzophenone®. Other suitable organic UV protectants are listed in Table 2.

TABLE 2
Para-Aminobenzoic Acid Derivatives such as:
PABA, Ethyl PABA
Ethyl Dihydroxypropyl PABA
Ethylhexyl Dimethyl PABA (marketed, in particular, under the trademark “Escalol 507” by ISP)
Glyceryl PABA
PEG-25 PABA(marketed under the trademark “Uvinul P25” by BASF)
Salicylic Derivatives such as:
Homosalate (marketed under the trademark “Eusolex HMS” by Rona/EM Industries)
Ethylhexyl Salicylate (marketed under the trademark “Neo Heliopan OS” by Haarmann and
Reimer)
Dipropyleneglycol Salicylate (marketed under the trademark “Dipsal” by Scher)
TEA Salicylate (marketed under the trademark “Neo Heliopan TS” by Haarmann and Reimer)
Cinnamic Derivatives such as:
Ethylhexyl Methoxycinnamate (marketed, in particular, under the trademark “Parsol MCX” by
Hoffmann-LaRoche)
Isopropyl Methoxy cinnamate, Isoamyl Methoxy cinnamate (marketed under the trademark
“Neo Heliopan E 1000” by Haarmann and Reimer)
Cinoxate
DEA Methoxycinnamate
Diisopropyl Methylcinnamate
Glyceryl Ethylhexanoate Dimethoxycinnamate
β,β-Diphenylacrylate Derivatives such as:
Octocrylene (marketed, in particular, under the trademark “Uvinul N539” by BASF)
Etocrylene (marketed, in particular, under the trademark “Uvinul N35” by BASF)
Benzophenone Derivatives such as:
Benzophenone-1 (marketed under the trademark “Uvinul 400” by BASF)
Benzophenone-2 (marketed under the trademark “Uvinul D50” by BASF)
Benzophenone-3 or Oxybenzone (marketed under the trademark “Uvinul M40” by BASF)
Benzophenone-4 (marketed under the trademark “Uvinul MS40” by BASF)
Benzophenone-5
Benzophenone-6 (marketed under the trademark “Helisorb 11” by Norquay)
Benzophenone-8 (marketed under the trademark “Spectra-Sorb UV-24” by American
Cyanamid)
Benzophenone-9 (marketed under the trademark “Uvinul DS-49” by BASF)
Benzophenone-12
Benzylidenecamphor Derivatives such as:
3-Benzylidene camphor (marketed under the trademark “Mexoryl SD” by Chimex)
Benzylidene Camphor Sulfonic Acid (marketed under the trademark “Mexoryl SL” by
Chimex)
Camphor Benzalkonium Methosulfate (marketed under the trademark “Mexoryl SO” by
Chimex)
Terephthalylidene Dicamphor Sulfonic Acid (marketed under the trademark “Mexoryl SX” by
Chimex)
Polyacrylamidomethyl Benzylidene Camphor (marketed under the trademark “Mexoryl SW”
by Chimex)
Phenylbenzimidazole Derivatives such as:
Phenylbenzimidazole Sulfonic Acid (marketed, in particular, under the trademark “Eusolex
232” by Merck)
Disodium Phenyl Dibenzimidazole Tetrasulfonate (marketed under the trademark “Neo
Heliopan AP” by Haarmann and Reimer)
Triazine Derivatives such as:
Anisotriazine (marketed under the trademark “Tinosorb S” by Ciba Specialty Chemicals)
Ethylhexyl triazone (marketed, in particular, under the trademark “Uvinul T150” by BASF)
Diethylhexyl Butamido Triazone (marketed under the trademark “Uvasorb HEB” by Sigma
3V)
2,4,6-tris(diisobutyl 4′-aminobenzalmalonate)-s-triazine
Phenylbenzotriazole Derivatives such as:
Drometrizole Trisiloxane (marketed under the trademark “Silatrizole” by Rhodia Chimie)
Methylenebis(benzotriazolyltetramethylbutylphenol) (marketed in the solid form under the
trademark “Mixxim BB/100” by Fairmount Chemical or in the micronized form in aqueous
dispersion under the trademark “Tinosorb M” by Ciba Specialty Chemicals)
Anthranilic Derivatives such as:
Menthyl anthranilate
Marketed under the trademark “Neo Heliopan MA” by Haarmann and Reimer
Imidazoline Derivatives such as:
Ethylhexyl Dimethoxybenzylidene Dioxoimidazoline Propionate
Benzalmalonate Derivatives such as:
Polyorganosiloxane comprising benzalmalonate functional group (marketed under the
trademark “Parsol SLX” by Hoffmann-LaRoche)
4,4-Diarylbutadiene Derivatives such as:
1,1-Dicarboxy(2,2′-dimethylpropyl)-4,4-dipenylbutadiene

The ability of a compound to absorb a particular wavelength at a given temperature is often expressed by the equation:

[α]_{λ}^{T}=εcl

where α is absorbance at temperature T and at wavelength λ, ε is the extinction coefficient of the compound, c is the concentration, and l is the length of photocell used to measure the UV absorbance. Unless specified otherwise, all absorbance referred to herein are at room temperature, e.g., 20° C. Typical UV absorbents used in the invention have a broad range of UV wavelength absorbance. Often the UV absorbent absorbs at least 30%, typically at least 50%, and more typically at least 70% of UV light. In general, the extinction coefficient of the UV absorbent is at least equal to, often greater than, the extinction coefficient of the pesticide within the UV light spectrum. Without being bound by any theory, it is believed that having the extinction coefficient of the UV absorbent at least equal to that of the pesticide allows the UV absorbent to substantially reduce the amount of UV light exposure to the pesticide. However, it should be appreciated that one can also affect the amount of UV light exposure to the pesticide by increasing the amount of UV absorbent relative to the amount of pesticide present in the composition.

In some embodiments, the UV absorbent comprises a mixture of at least one UV-A absorbent and at least one UV-B absorbent. In one particular embodiment, the UV absorbent comprises a benzophenone (e.g., benzophenone-3) and a benzotriazole derivative (e.g., commercially available solvent Tinuvin 571®, which is available from Ciba Specialty Chemicals Corp., Tarrytown, N.Y.). It should be appreciated that while some UV absorbents are categorized as being UV-A or UV-B absorbent, such UV absorbents are not limited to absorbing UV light within their respective category. The term UV-A absorbent means that the minimum extinction coefficient within UV-A range is greater than its UV-B absorbance. However, it does not mean that UV-A absorbent can not absorb any UV-B light. It merely means the extinction coefficient of UV-A absorbance is greater than its extinction coefficient for UV-B wavelength. Similarly, the term UV-B absorbent means that the compound's extinction coefficient of UV-B absorbent is greater than its extinction coefficient for UV-A wavelength. Simply put, UV-A absorbent has generally a higher absorbance for UV-A than UV-B and UV-B absorbent has generally a higher absorbance for UV-B than UV-A.

Compositions of the invention comprise a photolabile pesticide. A “photolabile pesticide” refers to a pesticide that is degraded by sunlight, in particular UV light. Pesticide refers to any compound that can control or eliminate a plant pest such as insects, weeds, and fungi. Exemplary pesticides include, but are not limited to, insecticides, herbicides, and fungicides. Particular exemplary photolabile pesticides include, but are not limited to, those listed in Table 1.

Typically, photolabile pesticides have a relatively short half-life when exposed to UV light. Such a short half-life span means the pesticide has to be re-applied several times during the plant's growing season. This increases the time and cost in planting plants as well as increasing the amount of potentially harmful chemicals used. In one aspect of the invention, the amount of time and cost as well as the frequency of pesticide application are significantly reduced by using a photolabile pesticide composition that comprises a UV absorbent. Without being bound by any theory, UV absorbent present within compositions of the invention absorbs UV light to protect and/or prolong the half-life of photolabile pesticide. Typically, the half-life of photolabile pesticide is increased by at least 25%, often by at least 50%, and more typically by at least 80%. Such increase in the half-life allows a plant pest to be exposed to the pesticide for a much longer period, thereby reducing the amount and/or the number of pesticide re-application.

In some embodiments, compositions of the invention can also include an organic solvent. A variety of suitable organic solvents are known to one skilled in the art. Typically these organic solvents comprise an aromatic organic solvent such as Aromatic 150 available from Exxon (Houston, Tex.). Other suitable organic solvents in compositions of the invention include all inert organic solvents that are conventionally employed in plant treatment products. Exemplary suitable organic solvents include, but are not limited to, glycols such as propylene glycol and polyethylene glycols having various molecular weights; ketones such as methyl isobutyl ketone, methyl isopropyl ketone and cyclohexanone; amides such as dimethyl- or diethyl formamide; N,N-dialkylated carboxamides (such as, for example, commercially-available solvent Hallcomid®); alkyllactams such as substituted pyrrolidones (such as, for example, N-methylpyrrolidone and commercially available solvent Surfadone®) and caprolactams (such as, for example, commercially available solvent Azone®); hydrocarbons, n-paraffins and isoparaffins having various boiling ranges as can be obtained (such as, for example, under the trade names Exxol®, Norpar® and Isopar®); aromatic hydrocarbons such as xylene and aromatic distillation fractions (such as, for example, commercially available solvent Solvesso®); esters such as propylene glycol monomethyl ether acetate, dibutyl adipate and di-n-butyl phthalate; ethers such as propylene glycol methyl ether or propylene glycol butyl ether; alcohols such as ethanol, n- and i-propanol, n- and i-butanol, n- and i-amyl alcohol, benzyl alcohol, tetrahydrofurfuryl alcohol, 1-methoxy-2-propanol, and higher alcohols, furthermore liquid carriers which have been obtained by modifying vegetable oils, such as, for example, rapeseed oil methyl ester and 2-ethylhexyl laurate; and furthermore dimethyl sulphoxide, dioxane and tetrahydrofuran. The organic solvents can be employed in the form of individual components or in the form of mixtures. Often organic solvents are miscible with the UV absorbent and/or the emulsifier and are not unduly volatile.

Still in embodiments, compositions of the invention can also include an emulsifier. Exemplary emulsifiers that are suitable for compositions of the invention include, but are not limited to, castor oil, and other emulsifiers such as, for example, commercially available emulsifier Sponto AG355N®, and mixtures of two or more thereof.

Typically pesticides are applied as an aqueous solution. Accordingly, compositions of the invention can also include water. Alternatively, compositions of the invention can be prepared just prior to or during its application to plants, for example by having a two separate vessels for organic material and aqueous material and mixing the two materials just prior to application or as they are being applied to plants.

Compositions of the invention can also include one or more adjuvants. Suitable adjuvants are well known to those skilled in the art.

The amount of each component in compositions of the invention is typical of those known to one skilled in the art. However, as stated above, because the half-life of the pesticide is significantly increased in compositions of the invention, the amount of pesticide present in compositions of the invention can be reduced significantly, thereby reducing the amount of pesticide needed.

Typically, the amount of photolabile pesticide in compositions of the invention ranges from about 0.1 to about 60 wt % of the total non-aqueous material. Often the amount of photolabile pesticide ranges from about 10 to about 50 wt %, and more often from about 20 to about 30 wt %, of the total non-aqueous material.

The amount of UV absorbent in compositions of the invention generally ranges from about 1 to about 20 wt % of the total non-aqueous material. Often the amount of UV absorbent ranges from about 6 to about 14 wt %, and more often from about 8 to about 12 wt %, of the total non-aqueous material.

When the UV absorbent comprises a UV-A absorbent compound and a UV-B absorbent compound, the amount of UV-A absorbent compound in compositions of the invention generally ranges from 0.5 to about 10 wt % of the total non-aqueous material. Often the amount of UV-A absorbent compound ranges from about 3 to about 7 wt %, and more often from about 4 to about 6 wt %, of the total non-aqueous material. The amount of UV-B absorbent compound generally ranges from 0.5 to about 10 wt % of the total non-aqueous material. Often the amount of UV-B absorbent compound ranges from about 3 to about 7 wt %, and more often from about 4 to about 6 wt %, of the total non-aqueous material. Typically, the relative ratio between the UV-A absorbent compound and the UV-B absorbent compound is about 1 to 1. However, it should be appreciated that the relative ratio of UV-A absorbent compound to UV-B absorbent compound is not limited to these specific ranges and examples given herein. The relative amount of UV-A and UV-B absorbent compounds can vary depending on the extinction coefficient of each of the compound.

When other additives such as an emulsifier, an organic solvent, adjuvant, or a mixture of two or more thereof are present, the amount of total additives generally ranges from about 35 to about 98 wt % of the total non-aqueous material. Often the total amount of additives ranges from about 50 to about 70 wt % of the total non-aqueous material.

The amount of organic solvent in compositions of the invention generally ranges from about 45 to about 65 wt % of the total non-aqueous material. Often the amount of organic solvent ranges from about 50 to about 60 wt %, and more often from about 55 to about 59 wt %, of the total non-aqueous material.

The amount emulsifier in compositions of the invention generally ranges from 3 to about 7 wt % of the total non-aqueous material. Often the amount of emulsifier ranges from about 4 to about 6 wt %, and more often from about 4.5 to about 5.5 wt %, of the total non-aqueous material.

However, it should be appreciated that the amount of individual components in the compositions of the invention can be varied within a wide range.

As stated above, the compositions of the invention can also comprise water. The water content prior to drying can vary within a wide range. It is generally between 0 and 80 wt %.

Suitable additives which can also be present in the compositions according to the invention are all those substances which are conventionally employed as additives in plant treatment products. They include polymers, surface-active substances, colorants, antioxidants, thickeners, fillers, antifreeze agents and solvents. Moreover, as stated above, the compositions according to the invention can also contain water.

Suitable polymers which can be present in the compositions according to the invention are all customary polymers or copolymers which are soluble or dispersible in water. Preferably suitable are polymers which are accessible by synthesis by means of anionic or non-ionic polymerization of suitable monomers, for example by emulsion polymerization or bead polymerization with the aid of free-radical formers or other initiator systems. Other polymers which can preferably be employed are those based on natural-rubber lattices.

Exemplary polymers which can be present in compositions of the invention include, but are not limited to, are following polymers: polyvinyl acetate (such as, for example, commercially available Mowilith®), polyvinyl alcohols with different degrees of hydrolysis (Mowiol®), polyvinylpyrrolidones (such as, for example, commercially available Lewiskod K® or Agrimer®), polyacrylates (such as, for example, commercially available Carbopol®), acrylate-, polyol- or polyester-based paint system binders which are soluble or dispersible in water (such as, for example, commercially available Desmophen®, Roskydal® or Bayhydrol®), moreover copolymers of two or more monomers such as acrylic acid, methacrylic acid, itaconic acid, maleic acid, fumaric acid, maleic anhydride, vinylpyrrolidone, ethylenically unsaturated monomers such as ethylene, butadiene, isoprene, chloroprene, styrene, divinylbenzene, ot-methylstyrene or p-methylstyrene, further vinyl halides such as vinyl chloride and vinylidene chloride, additionally vinyl esters such as vinyl acetate, vinyl propionate or vinyl stearate, moreover vinyl methyl ketone or esters of acrylic acid or methacrylic acid with monohydric alcohols or polyols such as methyl acrylate, methyl methacrylate, ethyl acrylate, ethylene methacrylate, lauryl acrylate, lauryl methacrylate, decyl acrylate, N,N-dimethylamino-ethyl methacrylate, 2-hydroxyethyl methacrylate, 2-hydroxypropyl methacrylate or glycidyl methacrylate, furthermore diethyl esters or monoesters of unsaturated dicarboxylic acids, furthermore (meth)acrylamido-N-methylol methyl ether, amides or nitriles such as acrylamide, methacrylamide, N-methylol(meth)acrylamide, acrylonitrile, methacrylonitrile, and also N-substituted maleiraides and ethers such as vinyl butyl ether, vinyl isobutyl ether or vinyl phenyl ether.

Suitable surface-active substances which can be present in the compositions of the invention are all those substances which have surface-active properties and which are conventionally used in plant treatment products. Often surface-active substances are non-ionic and anionic emulsifiers such as polyoxyethylene fatty acid esters, polyoxyethylene fatty alcohol ethers, alkylaryl polyglycol ethers, fatty amine ethoxylates, alkylsulphonates, alkyl sulphates, alkylarylsulphonates, aryl sulphates and silicone surfactants. Exemplary surface-active substances are listed in McCutcheon's Emulsifiers and Detergents, 1982, North America Edit, MC Publishing Co., 175 Rock Road, Glen Rock, N.J. 07 452, USA.

Suitable colorants are often soluble or sparingly soluble color pigments such as, for example, titanium dioxide, color black or zinc oxide.

Suitable antioxidants are well known to one skilled in the art and include substances that are usually employed in plant treatment products. Often antioxidants are sterically hindered phenols and alkyl-substituted hydroxyanisoles and hydroxytoluenes.

Suitable thickeners are also well known to one skilled in the art. These include substances that are usually employed in plant treatment products. Exemplary thickeners include, but are not limited to, the following: organic polymers such as partially or fully neutralized polyacrylic acids (such as, for example, commercially available Carbopol®), polyvinylpyrrolidone homo- or copolymers (such as, for example, commercially available Luviskol K® or Luviskol VA®), polyethylene glycols (such as, for example, commercially available Polyox®), ethylene oxide/propylene oxide copolymers (such as, for example, commercially available Pluronic®), polyvinyl alcohols and non-ionically or ionically modified celluloses (such as, for example, commercially available Tylose®), thixotropic xanthan-based thickeners (such as, for example, commercially available Kelzan®), and moreover inorganic disperse thickeners such as precipitated or pyrogenic silicas, kaolins, bentonites, aluminum/silicon mixed oxides, and silicates.

Suitable antifreeze agents are conventional substances that are usually employed for plant treatment products. Often antifreeze agents are urea, glycerol or propylene glycol.

Suitable fillers are typically inert materials that are conventionally employed in plant treatment products. Exemplary fillers include, but are not limited to, the following: ground minerals, calcium carbonate, ground quartz and aluminum/silicon mixed oxides or mixed hydroxides.

When preparing the compositions of the invention, a procedure is generally followed in which a premix is first prepared by dissolving or dispersing the UV absorbent and the pesticide in an organic solvent with stirring at temperatures typically between 20° C. and 70° C., often at room temperature, and, if appropriate, other additives such as an emulsifier are added. However, a different procedure can be followed when preparing compositions of the invention. For example, the premix can be dispersed in a solution of at least one surface-active substance, e.g., emulsifier, in water with stirring at temperatures typically between 20° C. and 70° C., often at room temperature. The dispersing process can be carried out in such a way that an oil-in-water emulsion is formed in which the average particle size is generally between 0.5 and 50 μm, typically between 1 and 20 μm. The resulting emulsion can subsequently be treated with a solution or dispersion of at least one polymer in water and, if appropriate, additives with stirring at temperatures typically between 20° C. and 70° C., often at room temperature. Still a different procedure can be followed when preparing the compositions of the invention. In general, it is possible to mix the components in any order. All stirring and mixing apparatus which is customary for this purpose is suitable for preparing the compositions of the invention.

The compositions of the invention are generally obtained from the preparation in a fluid or viscous state. Depending on the preparation process, they remain viscous after application or else form a non-flowable coating.

Some of the compositions of the invention are suitable for controlling harmful insects and undesirable representatives of the order Acarina which are found in agriculture, in forests and in horticulture, including viticulture. For example, they can be employed against the pests listed in Table 3.

TABLE 3

From the order of the Isopoda, for example:
Oniscus asellus
Armadillidium vulgare
Porcellio scaber
From the order of the Diplopoda, for example:
Blaniulus guttulatus
From the order of the Chilopoda, for example:
Geophilus carpophagus
Scutigera spec
From the order of the Symphyla, for example:
Scutigerella immaculata
From the order of the Thysanura, for example:
Lepisma saccharina
From the order of the Collembola, for example:
Onychiurus armatus
From the order of the Orthoptera, for example:
Blatta orientalis
Periplaneta americana
Leucophaea maderae
Blattella germanica
Acheta domesticus
Gryllotalpa spp.
Locusta migratoria migratorioides
Melanoplus differentialis
Schistocerca gregaria
From the order of the Dermaptera, for example:
Forficula auricularia
From the order of the Isoptera, for example:
Reticulitermes spp.
From the order of the Anoplura, for example:
Phylloxera vastatrix
Pemphigus spp.
Pediculus humanus corporis
Haematopinus spp.
Linognathus spp.
From the order cf the Mallophaga, for example:
Trichodectes spp.
Damalinea spp.
From the order of the Thysanoptera, for example:
Hercinothrips femoralis
Thrips tabaci
From the order of the Heteroptera, for example:
Eurygaster spp.
Dysdercus intermedius
Piesma quadrata
Cimex lectularius
Rhodnius prolixus
Triatoma spp.
From the order of the Homoptera, for example:
Aleurodes brassicae
Bemisia tabaci
Trialeurodes vaporariorum
Aphis gossypii
Brevicoryne brassicae
Cryptomyzus ribis
Aphis fabae
Doralis pomi
Eriosoma lanigerum
Hyalopterus arundinis
Macrosiphum avenae
Myzus spp.
Phorodon humuli
Rhopalosiphum padi
Empoasca spp.
Euscelis bilobatus
Nephotettix cincticeps
Lecanium corni
Saissetia oleae
Laodelphax striatellus
Nilaparvata lugens
Aonidiella aurantii
Aspidiotus hederae
Pseudococcus spp.
Psylla spp.
From the order of the Lepidoptera, for example:
Pectinophora gossypiella
Bupalus piniarius
Cheimatobia brumata
Lithocolletis blancardella
Hyponomeuta padella
Plutella maculipennis
Malacosoma neustria
Euproctis chrysorrhoea
Lymantria spp.
Bucculatrix thurberiella
Phyllocnistis citrella
Agrotis spp.
Euxoa spp.
Feltia spp.
Earias insulana
Heliothis spp.
Spodoptera exigua
Mamestra brassicae
Panolis flammea
Prodenia litura
Spodoptera spp.
Trichoplusia ni
Carpocapsa pomonella
Pieris spp.
Chilo spp.
Pyrausta nubilalis
Ephestia kuehniella
Galleria mellonella
Tineola bisselliella
Tinea pellionella
Hofmannophila pseudospretella
Cacoecia podana
Capua reticulana
Choristoneura fumiferana
Clysia ambiguella
Homona magnanima
Tortrix viridana
From the order of the Coleoptera, for example:
Anobium punctatum
Rhizopertha dominica
Acanthoscelides obtectus
Bruchidius obtectus
Hylotrupes bajulus
Agelastica alni
Leptinotarsa decemlineata
Phaedon cochleariae
Diabrotica spp.
Psylliodes chrysocephala
Epilachna varivestis
Atomaria spp.
Oryzaephilus surinamensis
Anthonomus spp.
Sitophilus spp.
Otiorrhynchus sulcatus
Cosmopolites sordidus
Ceuthorrhynchus assimilis
Hypera postica
Dermestes spp.
Trogoderma spp.
Anthrenus spp.
Attagenus spp.
Lyctus spp.
Meligethes aeneus
Ptinus spp.
Niptus hololeucus
Gibbium psylloides
Tribolium spp.
Tenebrio molitor
Agriotes spp.
Conoderus spp.
Melolontha melolontha
Amphimallon solstitialis
Costelytra zealandica
From the order of the Hymenoptera, for example:
Diprion spp.
Hoplocampa spp.
Lasius spp.
Monomorium pharaonis
Vespa spp.
From the order of the Diptera, for example:
Aedes spp.
Anopheles spp.
Culex spp.
Drosophila melanogaster
Musca spp.
Fannia spp.
Calliphora erythrocephala
Lucilia spp.
Chrysomyia spp.
Cuterebra spp.
Gastrophilus spp.
Hyppobosca spp.
Stomoxys spp.
Oestrus spp.
Hypoderma spp.
Tabanus spp.
Tannia spp.
Bibio hortulanus
Oscinella frit
Phorbia spp.
Pegomyia hyoscyami
Ceratitis capitata
Dacus oleae
Tipula paludosa
From the order of the Siphonaptera, for example:
Xenopsylla cheopis
Ceratophyllus spp.
From the order of the Arachnida, for example:
Scorpio maurus
Latrodectus mactans
From the order of the Acarina, for example:
Acarus siro
Argas spp.
Ornithodoros spp.
Dermanyssus gallinae
Eriophyes ribis
Phyllocoptruta oleivora
Boophilus spp.
Rhipicephalus spp.
Amblyomma spp.
Hyalomma spp.
Ixodes spp.
Psoroptes spp.
Chorioptes spp.
Sarcoptes spp.
Tarsonemus spp.
Bryobia praetiosa
Panonivchus spp.
Tetranychus spp.

Some of the compositions of the invention are suitable for controlling harmful plants (e.g., weeds). Suitable photolabile herbicides are well known to one skilled in the art. Any of such photolabile herbicides can be used in compositions of the invention.

Some of the compositions of the invention are suitable for controlling harmful fungi. Suitable photolabile fungicides are also well known to one skilled in the art. Any of such photolabile fungicides can be used in compositions of the invention.

Using conventional devices as they are known to those skilled in the art the compositions of the invention can be applied to, and distributed on, the areas under cultivation or plants to be treated in the form of droplets, the drop-size range or thin limited layers. Particularly suitable for the treatment of orchard crops or grape vines is a process in which a defined amount of the formulations according to the invention is applied to the stems of the plants with the aid of dosing dispensers, pipettes or syringes, it being possible for the application device also to be provided with a spreading device or a broad-jet nozzle so as to apply the compositions broadly over a relatively large area. It is also possible to spread the formulations of the invention on a solid support, where they are allowed to dry.

The amounts in which the compositions of the invention are applied can vary within a substantial range. They are in general in the order of magnitude which is conventionally used.

Additional objects, advantages, and novel features of this invention will become apparent to those skilled in the art upon examination of the following examples thereof, which are not intended to be limiting.

### EXAMPLES

### Example 1

A solution of insecticide composition was prepared as follows: UV-A and UV-B absorber (total about 5-15 wt %), insecticide (about 20-30 wt %), and emulsifiers (total about 2-10 wt %), and a solvent being the remainder.

### Example 2

An aqueous solution of a pyrethroid compound was irradiated with light at environmentally significant wavelengths. The half-life of this solution was about 21 hours. The same compound in the presence of UV-A and UV-B protectants had the half-life that was significantly longer. Even after two days, the mixture having UV-A and UV-B protectants did not show a significant degradation.

### Example 3

The capacity of a commercial insecticide (known as Tombstone™) to absorb UV radiation was compared to that of a composition combining the same insecticide with a photoprotectant according to one embodiment.

The Tombstone™ insecticide composition consisted of the following ingredients:

| Ingredient | Weight % |
|---|---|
| Aromatic 150 | 68.17 |
| Cyfluthrin Tech | 25.83 |
| Emulsifier (Sponto ™ AG355N) | 5.00 |
| Emulsifier (36 mole castor oil) | 1.00 |

Cyfluthrin has the following formula: cyano(4-fluoro-3-phenoxyphenyl)methyl-3-(2,2-dichloroethenyl)-2,2-dimethyl-cyclopropanecarboxylate. Sponto™ AG355N is available from Witco/Akzo-Nobel.

The insecticide+photoprotectant composition (“I+P Comp”) according to one embodiment consisted of the following ingredients:

| Ingredient | Weight % |
|---|---|
| Aromatic 150 | 58.17 |
| Benzophenone-3 | 5.00 |
| Tinuvin ® 571 | 5.00 |
| Cyfluthrin Tech | 25.83 |
| Emulsifier (Sponto ™ AG355N) | 5.00 |
| Emulsifier (36 mole castor oil) | 1.00 |

in which both benzophenone-3 and Tinuvin 571 are photoprotectants. The above ingredients were mixed with water at a ratio of 2 lbs of the composition per gallon of water.

The UV absorption of each composition was tested using a spectrophotometer.

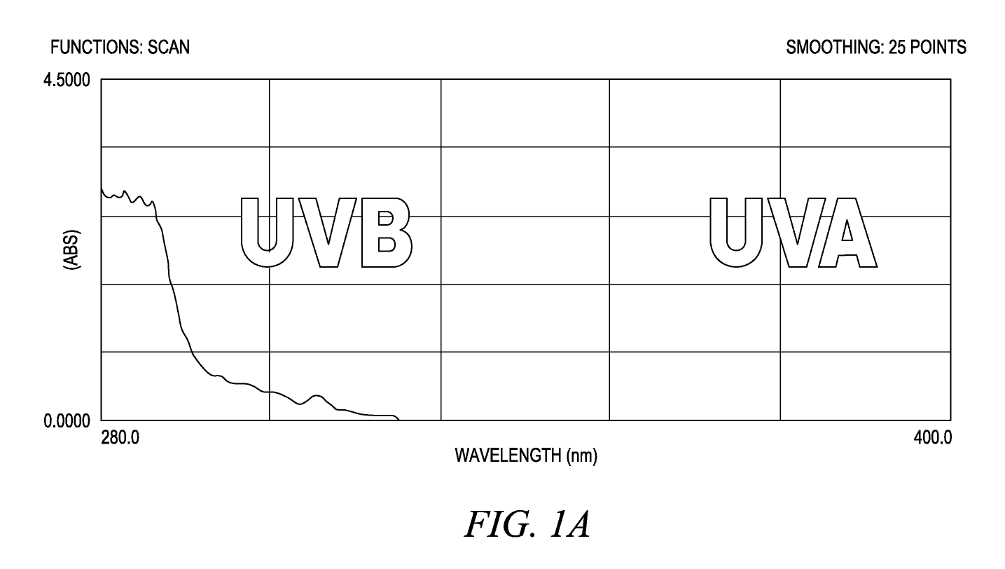

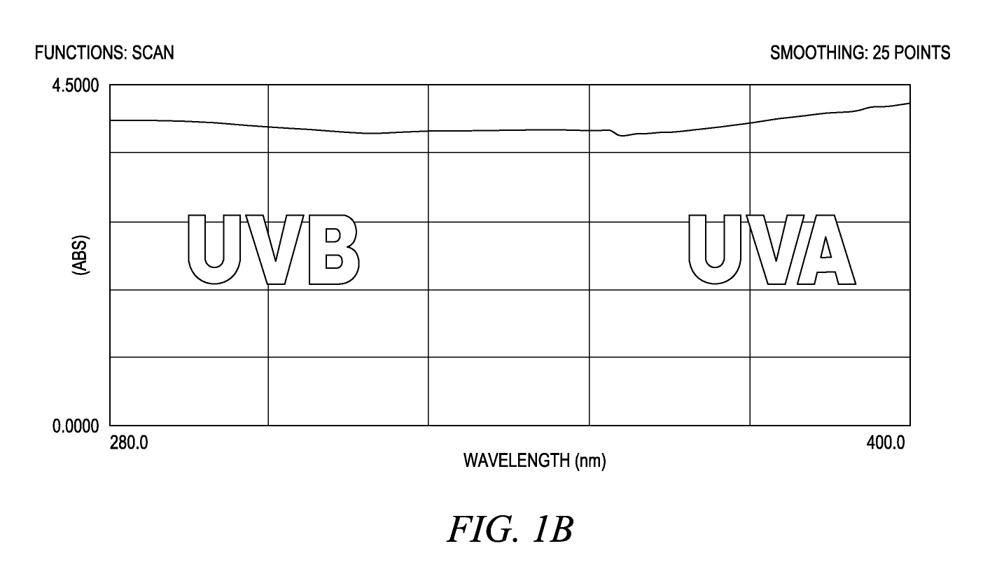

FIGS. 1A and 1B exhibit the results of the testing. FIG. 1A shows that the commercial insecticide alone absorbed some UV-B radiation. In contrast, FIG. 1B shows that the I+P Comp absorbed both UV-B and UV-A radiation throughout the UV-B and UV-A spectrum.

### Example 4

The ability of the commercial insecticide of Example 3 to prevent photodegradation was compared to that of the I+P Comp of Example 3 using a photodegradable dye.

Four glass bottles were each filled with a mixture of photodegradable dye and water (the ratio of dye to water being identical in each bottle). The commercial insecticide was added to two bottles, and the I+P Comp was added to the other two bottles. Subsequently, one bottle of the commercial insecticide and one bottle of the I+P Comp were placed outside in a location where each bottle could be struck directly by sunlight, and the bottles were exposed to a total of 21 hours of sunlight. Further, one bottle of the commercial insecticide and one bottle of the I+P Comp were placed in a drawer and were not allowed to be exposed to any sunlight.

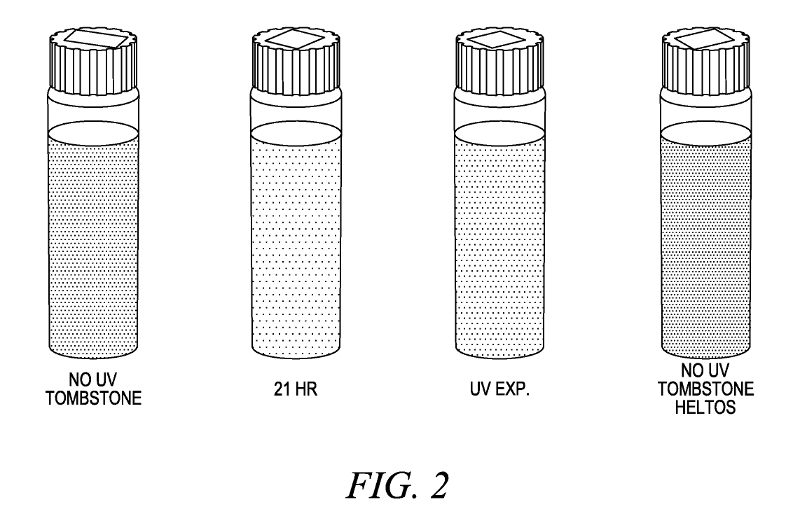

FIG. 2 depicts the results of the test. Bottles 1 and 2 contain the commercial insecticide, while bottles 3 and 4 contain the I+P Comp. Further, bottles 1 and 4 (counting from the left) were the bottles placed in the drawer (as controls), while bottles 2 and 3 were the bottles exposed to sunlight. As shown in FIG. 2, the photodegradable dye in the bottle of commercial insecticide (bottle 2) that was exposed to the sun had been completely broken down, thereby exhibiting a white color. In contrast, the photodegradable dye in the bottle of I+P Comp (bottle 3) that was exposed to the sun had not been broken down, as evidenced by the blue color indicating that the dye had not been degraded.

### Example 5

The effectiveness of the commercial insecticide of Example 3 after UV exposure was compared to that of the I+P Comp of Example 3. In this example, a number of Petri dishes, each containing an absorbent fiber, were treated with the commercial insecticide (“control dishes”), and a number of Petri dishes were treated with the I+P Comp (“test dishes”). Both the control composition and the test composition were added to the dishes at a rate of 1.6 ounces/Acre. In this example, three Petri dishes were treated with the test composition and three were treated with the control composition.

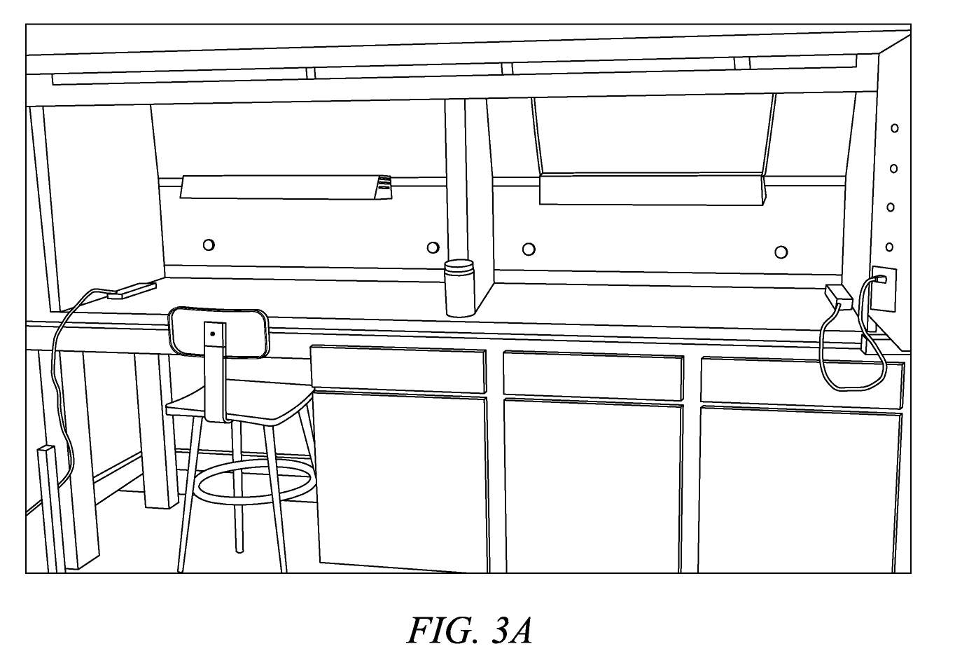

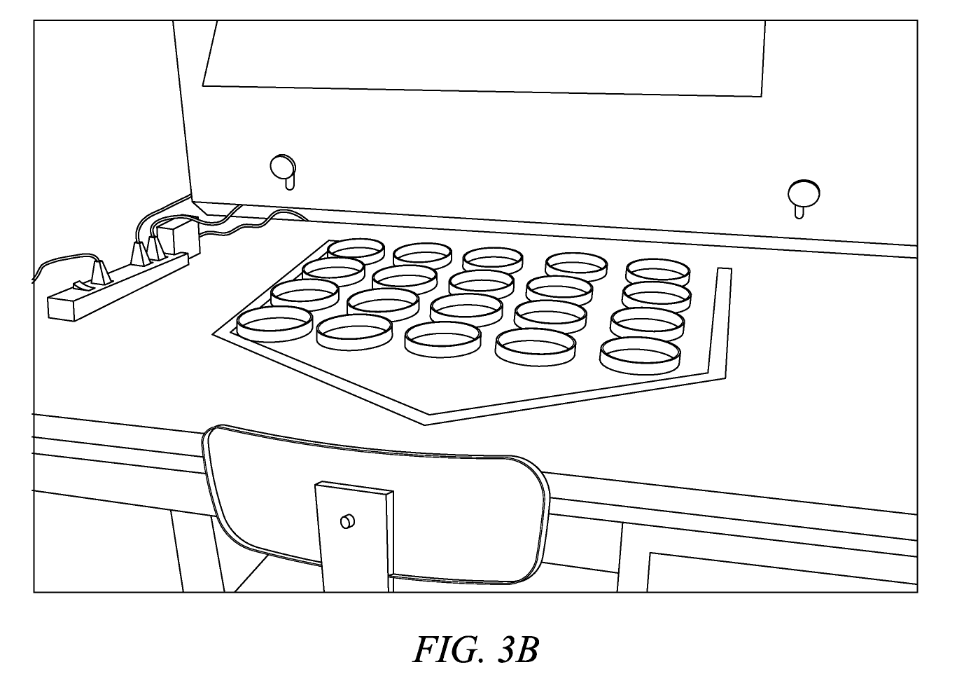

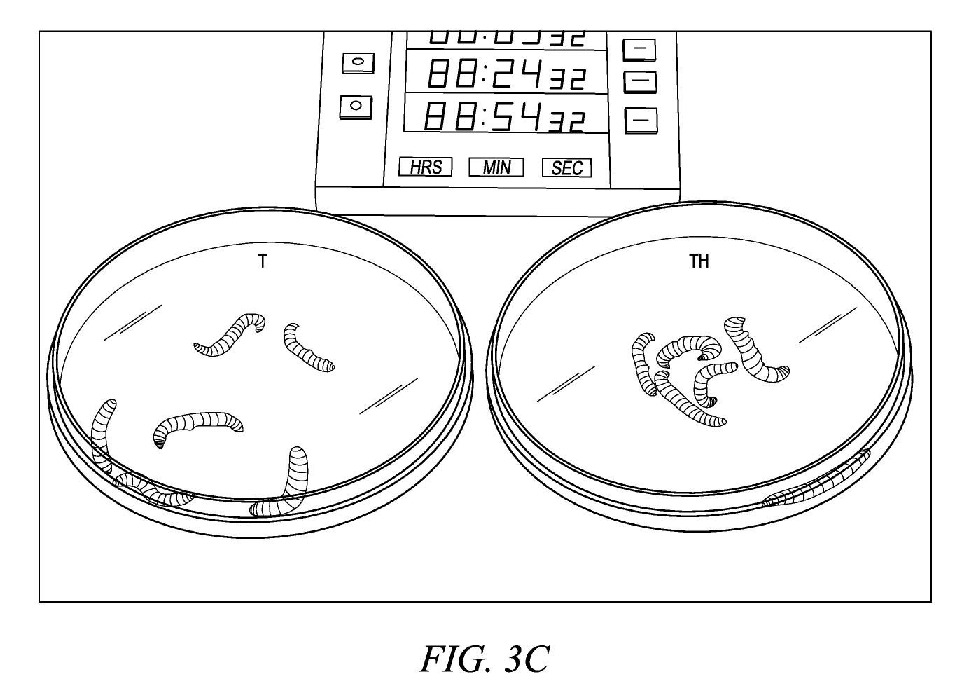

After treatment, the test and control dishes were then exposed to artificial UV-A and UV-B light in the exposure areas (also referred to herein as “light stalls”) depicted in FIG. 3A. Each stall had three UV-A/UV-B bulbs disposed above the dish-receiving surface. For purposes of this experiment, the UV light arrangement was the ESU Reptile Combo-Light™, which has a combination of two ReptiSun™ Compact Fluorescent UV-B Lamps (10.0 UVB) and one ReptiSun™ Linear Fluorescent Tube (10.0 UVB), all of which are distributed by Zoo Med Laboratories Inc., located in San Luis Obispo, Calif.

The dishes were arranged in one of the light stalls under the lights as shown in FIG. 3B. One test dish and one control dish were each exposed to the UV-A and UV-B light for 236 hours. Another test dish and control dish were each exposed for 260 hours. Finally, a third pair of dishes (one test and one control) were each exposed for 306.5 hours.

After exposure to the UV light, six black cutworm larvae at the second instar were introduced into each Petri dish and the time to mortality was monitored. More specifically, the time was recorded when each cutworm become entirely inactive. FIG. 3C depicts one test dish (designated “TH”) and one control dish (designated “T”) during the mortality monitoring period. Due to the lengthy time to mortality in the 236 hour exposure test, each of the dishes in the 260 and

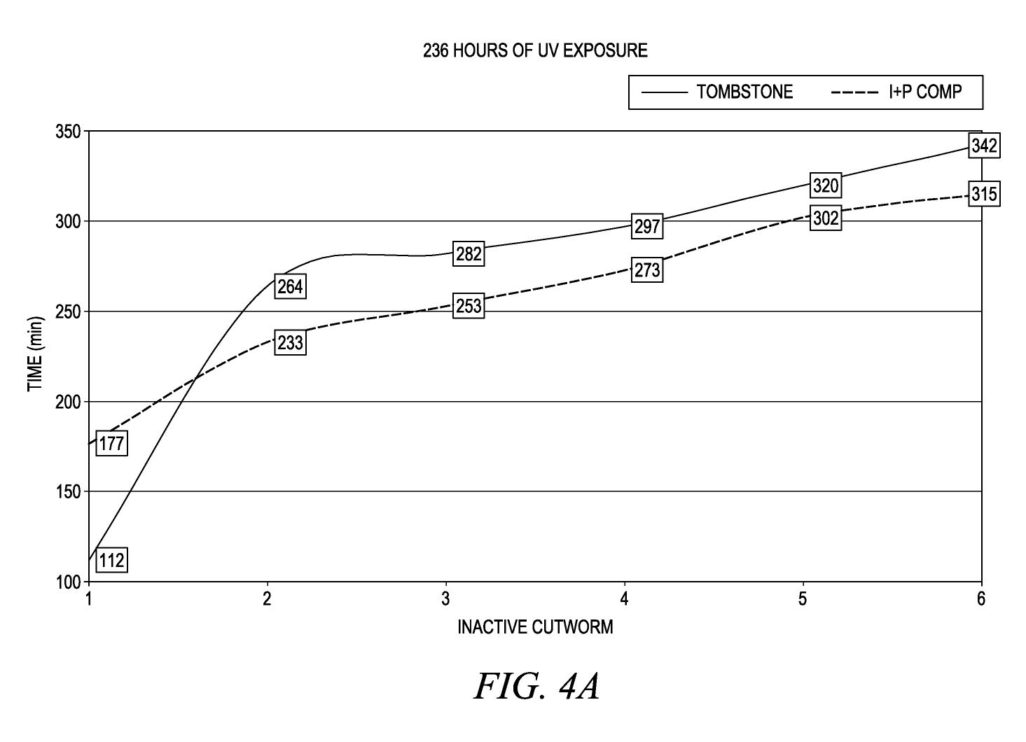

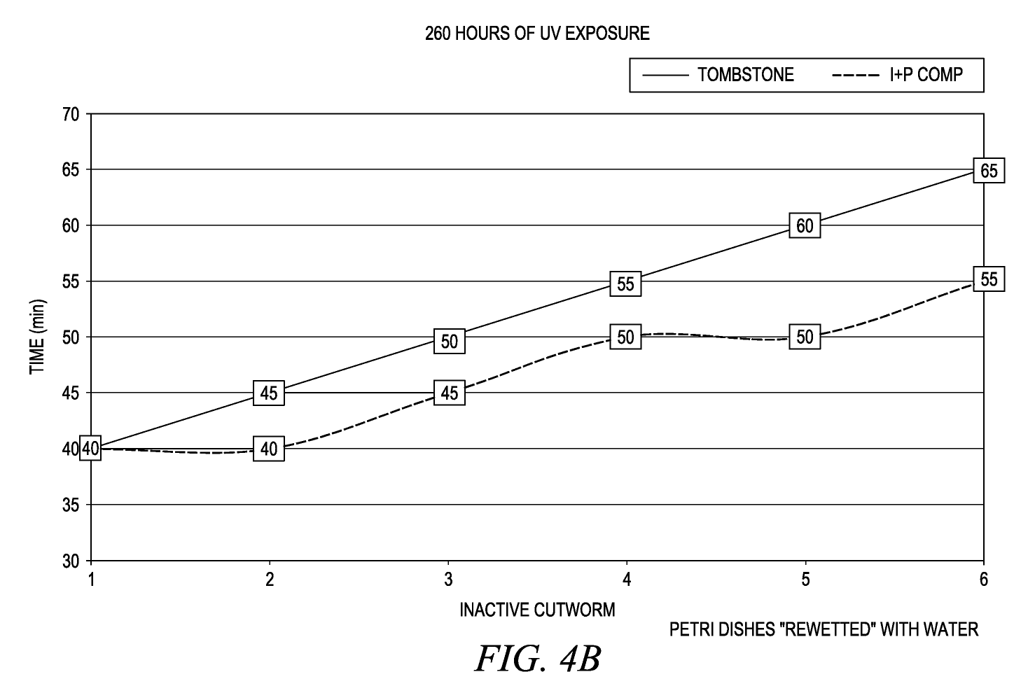

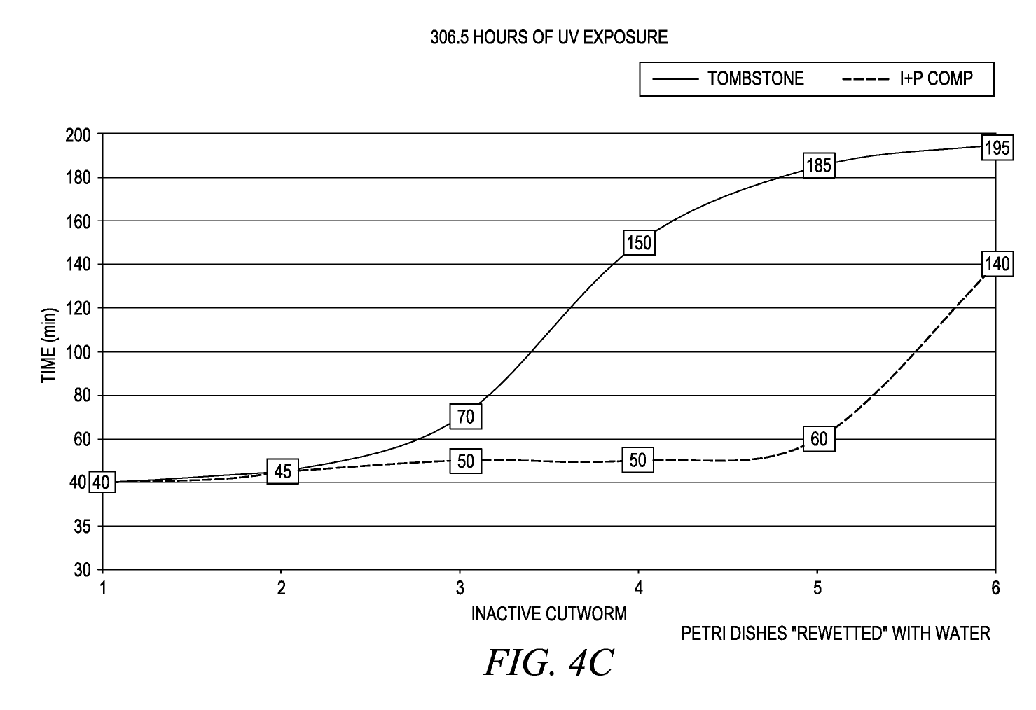

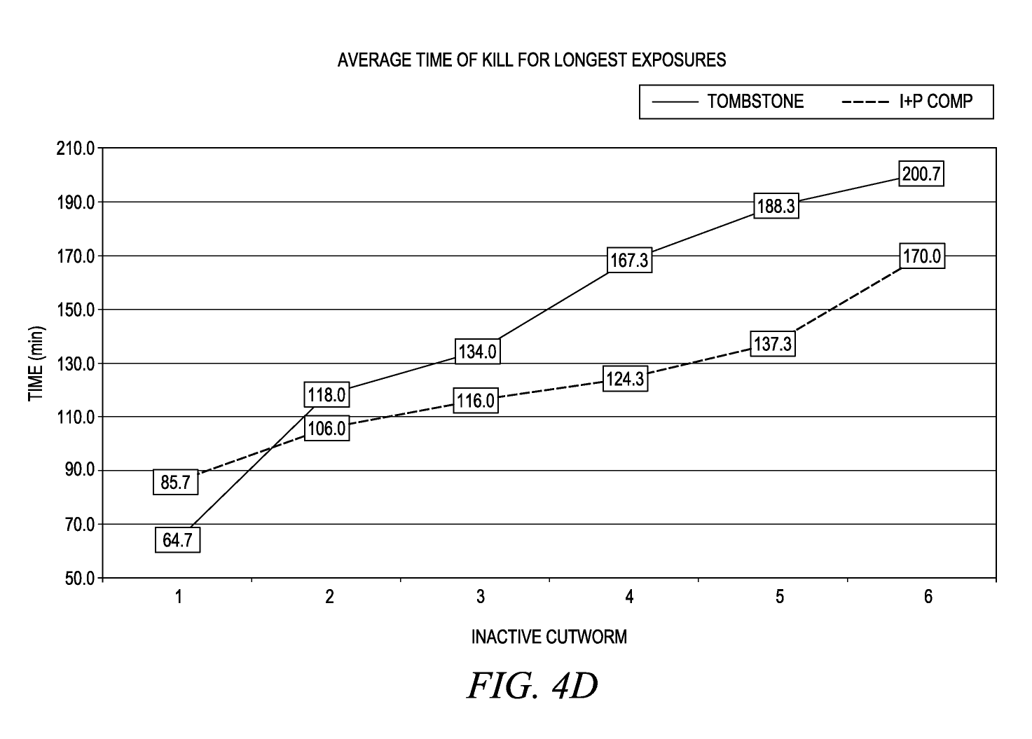

The results for the three groups of dishes are shown in FIGS. 4A, 4B, 4C, and 4D. Each figure shows the time at which each of the six cutworms became inactive in each dish. FIG. 4A depicts the results for the two dishes exposed to the UV light for 236 hours. FIG. 4B depicts results for the dishes exposed for 260 hours. FIG. 4C depicts results for the dishes exposed for 306.5 hours. Finally, FIG. 4D depicts the average time to mortality for all three exposure periods.

As can be seen in the graphs, the I+P Comp exhibited a faster average mortality than the control composition except with respect to the first cutworm to die in the 236 hour exposure test.

### Example 6

The present example is similar to Example 5. That is, the test examined the impact of UV light on the degradation of an insecticide without a photoprotectant in comparison to the degradation of a composition combining an insecticide with a photoprotectant according to one embodiment. As in Example 5, one group of Petri dishes was treated with the test composition and another group was treated with the control composition, both compositions being added at a rate of 1.6 ounces/Acre.

After treatment, the test and control dishes were then exposed to artificial UV-A and UV-B light. One group of test and control dishes were exposed to the UV-A and UV-B light for 72 hours. Another group was exposed for 144 hours. Three other groups were exposed for 192, 240, and 288 hours respectively.

After exposure to the UV light, six black cutworm larvae at the second instar were introduced into each Petri dish and the time to mortality was monitored. Subsequently, the test was repeated four times and the results were averaged for those four tests.

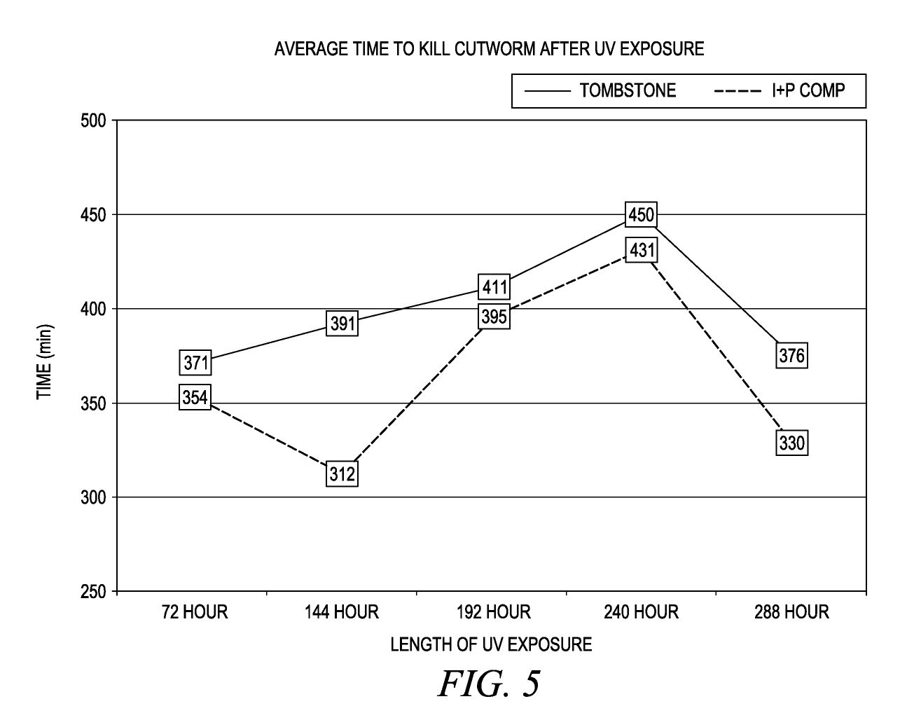

The resulting averages are shown in Table 4 below and also in graphical form in FIG. 5.

TABLE 4
Mean time (minutes) for mortality of black cutworm larva

| UV interval (hrs) | Control Composition | Test Composition |
|---|---|---|
| 72 | 371 | 354 |
| 144 | 391 | 312 |
| 192 | 411 | 394 |
| 240 | 449 | 431 |
| 288¹ | 375 | 329 |

¹Black cutworm larva were slightly smaller in this group, which may have resulted in faster time to mortality.

The I+P Comp exhibited a faster average mortality than the control composition at every UV exposure period. More specifically, the average mortality rate was 9% faster in the test dishes in comparison to the control dishes.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A pesticide composition comprising a photolabile pesticide and a UV protectant.

2. The pesticide composition of claim 1, wherein said photolabile pesticide comprises a photolabile insecticide, a photolabile herbicide, a photolabile fungicide, or combinations thereof.

3. The pesticide composition of claim 2, wherein said photolabile insecticide comprises a photolabile neonicitinoid, a photolabile pyrethroid, a photolabile bio-pesticide, any other photolabile pesticide, or combinations thereof.

4. The pesticide composition of claim 2, wherein said photolabile herbicide comprises a photolabile chloroacetamide, a photolabile herbicide, or combinations thereof.

5. The pesticide composition of claim 2, wherein said photolabile fungicide comprises a photolabile biofungicide.

6. The pesticide composition of claim 1, wherein said UV protectant is a mixture of at least two different UV protectant compounds.

7. The pesticide composition of claim 6, wherein at least one of said UV protectant compound is UV-A absorbent compound and at least one of the other UV protectant compound is UV-B absorbent compound.

8. The pesticide composition of claim 1, wherein said UV protectant comprises a UV absorbent.

9. The pesticide composition of claim 8, wherein said UV absorbent absorbs at least 50% of UV light.

10. The pesticide composition of claim 1, wherein said UV protectant comprises an organic compound.

11. The pesticide composition of claim 1 further comprising an organic solvent.

12. The pesticide composition of claim 11 further comprising an emulsifier.

13. The pesticide composition of claim 1, wherein said UV protectant is a UV absorbent with the extinction coefficient greater than the extinction coefficient of the pesticide within a range of wavelengths from about 200 nm to about 400 nm.

14. A pesticide composition comprising:
a photolabile pesticide in the amount from about 0.1 to about 60 wt % of the total non-aqueous material;
a UV protectant in the amount from about 1 to about 20 wt % of the total non-aqueous material; and
optionally an additive comprising an emulsifier, an organic solvent, an adjuvant, or a mixture of two or more thereof, wherein the amount of the total additive ranges from about 35 to about 98 wt % of the total non-aqueous material.

15. The pesticide composition of claim 14, wherein said photolabile pesticide comprises a photolabile insecticide, a photolabile herbicide, a photolabile fungicide, or combinations thereof.

16. The pesticide composition of claim 14, wherein said photolabile pesticide is a photolabile insecticide.

17. The pesticide composition of claim 16, wherein said photolabile insecticide is a pyrethroid.

18. The pesticide composition of claim 14, wherein the amount of UV protectant is from about 6 to about 14 wt % of the total non-aqueous material.

19. The pesticide composition of claim 14, wherein the amount of photolabile pesticide is from about 15 to about 30 wt % of the total non-aqueous material.

20. The pesticide composition of claim 14, wherein said UV protectant comprises a mixture of a UV A absorbent and a UV B absorbent.

21. The pesticide composition of claim 20, wherein said UV protectant comprises a mixture of benzophenone-3 and an absorbent.

22. The pesticide composition of claim 14, wherein the amount of additive is from about 50 to about 70 wt % of the total non-aqueous material.

23. The pesticide composition of claim 14, wherein the additive comprises an emulsifier and an organic solvent.

24. The pesticide composition of claim 23, wherein the amount of emulsifier is from about 3 to about 7 wt % of the total non-aqueous material.

25. The pesticide composition of claim 24, wherein the emulsifier comprises castor oil, another emulsifier, or a mixture thereof.

26. The pesticide composition of claim 23, wherein the amount of organic solvent is from about 45 to about 65 wt % of the total non-aqueous material.

27. A method for increasing the half-life of a photolabile pesticide when applied to a plant, said method comprising admixing the photolabile pesticide with a UV protectant.

28. The method of claim 27, wherein said admixing step comprises admixing the photolabile pesticide and the UV protectant prior to applying the photolabile pesticide to a plant.

29. The method of claim 27, wherein said admixing step comprises separately applying the photolabile pesticide and the UV protectant to a plant.

30. The method of claim 27, wherein said admixing step comprises simultaneously applying the photolabile pesticide and the UV protectant to a plant from a separate vessel.

31. The method of claim 27, wherein the photolabile pesticide comprises a photolabile insecticide, a photolabile herbicide, a photolabile fungicide, or combinations thereof.

32. The method of claim 31, wherein the photolabile pesticide is a photolabile insecticide.

33. The method of claim 32, wherein the photolabile insecticide is a pyrethroid.

34. The method of claim 27, wherein the UV protectant comprises a UV absorbent.

35. The method of claim 34, wherein the UV absorbent has the extinction coefficient greater than the extinction coefficient of the photolabile pesticide in a range of wavelengths ranging from about 200 nm to about 400 nm.

36. A method for increasing the half-life of a photolabile pesticide, said method comprising admixing the photolabile pesticide with a photoprotectant that is capable of protecting the photolabile pesticide from light that degrades the photolabile pesticide.

37. The method of claim 36, wherein the amount of photoprotectant present in the admixture is such that the amount of light that the photolabile pesticide is exposed to is reduced by at least about 50%.

38. The method of claim 36, wherein the wavelength of light that degrades the photolabile pesticide is between/about 200 nm to about 400 nm.

39. The method of claim 38, wherein the photoprotectant comprises a UV absorbent.

40. The method of claim 39, wherein the UV absorbent comprises a mixture of compounds comprising a UV-A absorbent compound and a UV-B absorbent compound.

41. The method of claim 36, wherein the photoprotectant comprises at least about 10 wt % of the total non-aqueous material.
